(19) United States
(12) Patent Application Publication
(10) Pub. No.: US 2010/0306517 A1
(43) Pub. Date: Dec. 2, 2010

(54) SECURITY OF OPERATION OF A COMPUTING DEVICE THROUGH THE USE OF VENDOR IDS

(75) Inventors: Corinne Dive-Reclus, Hertfordshire (GB); Geoff Preston, Malmesbury (GB); Andrew Harker, Herts (GB)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SYMBIAN SOFTWARE LTD., London (GB)

(21) Appl. No.: 12/063,058

(22) PCT Filed: Aug. 8, 2006
(86) PCT No.: PCT/GB06/02954

§ 371 Date: Jul. 28, 2010

(30) Foreign Application Priority Data
Aug. 10, 2005 (GB) 0516443

(51) Int. Cl. G06F 9/00

(52) U.S. Cl. 713/1

(57) ABSTRACT

An installer for a computing device determines firstly whether or not a software package for installation has been signed. If the package is signed it is installed on the device. However, if the package is unsigned, the installer will only install the package on the device if it contains a non-null VID (vendor identity).

The present invention relates to a means for improving the security of operation of a computing device, and in particular to a means for improving the security of operation of a computing device through the use of vendor IDs for identifying the company owning the source code of applications for mobile phones having open platforms.

The term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of device already mentioned, together with many other industrial and domestic electronic appliances.

A computing device that allows its owner or user to install software providing new applications or new functionality is termed an open device. Though there are clear benefits to being able to extend the utility of a device in this way, it is apparent that this facility can represent a significant security risk for the owner or user. Where the computing device is connected to other devices over a network, the risk can extend to all other devices connected to the network, and threatens even the integrity of the network itself.

There is now widespread awareness that there is a significant risk of malicious programs (or malware) affecting open computing devices. A recent Internet article (http://en.wikipedia.org/wiki/Malware) identifies and describes eleven different types of malware, which include Viruses, Worms, Wabbits, Trojans, Backdoors, Spyware, Exploits, Rootkits, Key Loggers, Dialers and URL injectors.

The ability to obtain reliable information about the company or individual that originated any item of software is an invaluable aid in helping to define the level of trust that can be applied to that item of software. This is true not only of users, but more especially of the operating system (OS) and associated services that may be running on the computing device.

One solution to this problem is for software to be allocated a globally unique vendor identity (VID) which can be retrieved by the device; this is simply a number that can be uniquely associated with a specific manufacturer or vendor. Retrieving the VID enables the author to be identified, and this in turn provides evidence that the item can be trusted.

VIDs are in use in many areas of technology involving computing devices. They are widespread in hardware devices; see http://www.computerhope.com/jargon/v/vendorid.htm for a definition. Http://www.usb.org/developers/vendor/provides examples of how devices incorporating the Universal Serial Bus may include a vendor ID in their products; and http://www.pcidatabase.com/vendors.php?sort=id includes a list of all the vendor IDs used by makers of PCI cards. Vendor IDs are also used for software packages. Http://www.palmos.com/dev/tech/palmos/creatorid/describes how Creator IDs are allocated in Palm OS, and http://www.ietf.org/rfc/rfc2408.txt?number=2408 discusses the use of Vendor IDs in accessing proprietary extensions to the Internet Key Exchange protocol.

The implementations of Vendor ID given above are not terribly useful in a security sense. None of the vendor IDs provides actual proof against impersonation or spoofing. This matters less, perhaps, for Vendor IDs incorporated in hardware, as hardware is not generally susceptible to the same sort of attack by malicious software; but the fact that Vendor ID is not itself proof against spoofing is something of a flaw. Clearly, a manufacturer of malicious software is not going to worry about procuring a third party VID. In fact, if it is likely to make the malware more attractive and more acceptable as being genuine to a user, it is something that the manufacturer of the malicious software is quite likely to do.

This issue can, of course, be solved by incorporating the VID into a secure digitally signed certificate. But, if this is done, it makes the VID itself redundant as a security measure, since the certificate chain itself can be checked to see who has signed it, and this is well known to be an excellent method of establishing trust.

However, digitally signed certificates are only useful when installing software. They are computationally very expensive and are far too heavyweight for continuous use in a computing device at run time.

In contrast, VIDs are quick and simple to check, requiring only an arithmetic comparison. This makes them practical for use when software needs to be checked for its origin once the software is on the device. Unfortunately, previous implementations of VIDs do not provide sufficient confidence to rely on them as categoric proof of identity at run-time.

The present invention allows an open computing device to have as much confidence in an application's VID when checked at run time as it has in the digital certificate with which the application was signed when installed.

According to a first aspect of the present invention there is provided a method of operating a computing device wherein
a. each executable is optionally assigned either a vendor identity (VID) at build time or a null VID of zero; and
b. the VID is included as part of the metadata in the executable file format used by the device; and
c. all executables not included on the device at the time of manufacture are installed on the device by a single component (the installer) before it is able to run; and
d. when an application package is installed on the device, the installer checks to see that it is appropriately signed; and
e. if the package is unsigned, the installer program verifies that the package includes no executables containing any VID apart from the null VID; and
f. the signing process for packages includes the distribution of all allocated VIDs to all signing authorities for ensuring at application signing time that any executables contained in application packages contain the correct VIDs.

According to a second aspect of the present invention there is provided a computing device arranged to operate in accordance with a method of the first aspect.

According to a third aspect of the present invention there is provided an operating system for causing a computing device to operate in accordance with a method of the first aspect.

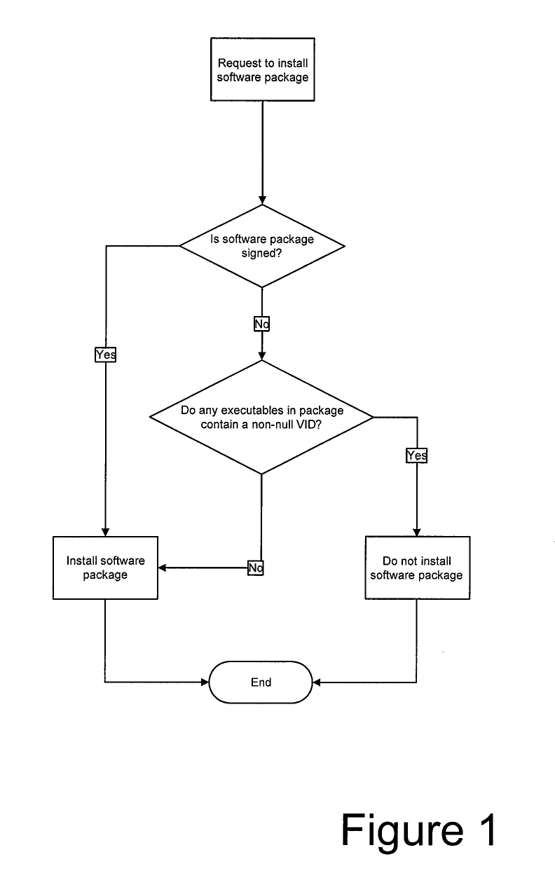

An embodiment of the present invention will now be described, by way of further example only, with reference to FIG. 1, which shows an embodiment of the present invention.

The invention may be regarded as being based upon the following elements:
1. Each executable destined for a computing device is optionally assigned a VID at build time (when compiled and linked); a null VID of zero is used for executables for which no VID is assigned.
2. The VID is included as part of the metadata in the executable file format used by the device.
3. The computing device includes an installation program that is the sole method of installing software on the device after manufacture.
4. When an application package is installed on the device, the installation program checks to see that the package is appropriately signed.
5. If the package is unsigned, the installation program verifies that it includes no executables containing a VID (except for the null VID).
6. The signing process for packages must include the distribution of all allocated VIDs to all signing authorities, who must ensure at application signing time that any executables contained in packages contain the correct VIDs.

In summary, therefore, each executable is assigned a Vendor ID as part of the executable file format.

Referring to FIG. 1, when an application package is to be installed on a computing device, which may be in the form of a mobile phone, a request to install the package is made to the device. In response, the installer on the device verifies if the application package is appropriately signed. If the package is signed, the software package is installed. However, if the package is unsigned, the installer verifies whether or not any executable within the package contains a non-null VID; i.e it has been assigned a Vendor ID. If the answer is ‘Yes’, the installer does not proceed with the installation of the package, as can be seen from FIG. 1. However, if the answer is ‘No’, the software package is installed. In summary, therefore, the software package is installed if it signed or it contains a verifiable VID.

The invention relies therefore on an appropriate application signing program to distribute VIDs across all signing authorities who must ensure at application signing time that executables contain correct VIDs.

This invention offers clear advantages over previous methods in that VIDs which are checked at run-time can be given the same level of trust as the cryptographic mechanisms used for digital certificates, even though a VID is simply a number. Furthermore, operating systems can easily identify the provenance of the code without requiring any cryptography methods. Additionally, on certain devices, this can be used to enable the locking of some services or resources to software from specific vendors only.

Although the present invention has been described with reference to particular embodiments, it will be appreciated that modifications may be effected whilst remaining within the scope of the present invention as defined by the appended claims.

1. A method of operating a computing device wherein
a. each executable is optionally assigned either a vendor identity (VID) at build time or a null VID of zero; and
b. the VID is included as part of the metadata in the executable file format used by the device; and
c. all executables not included on the device at the time of manufacture are installed on the device by a single component (the installer) before it is able to run; and
d. when an application package is installed on the device, the installer checks to see that it is appropriately signed; and
e. if the package is unsigned, the installer program verifies that the package includes no executables containing any VID apart from the null VID; and
f. the signing process for packages includes the distribution of all allocated VIDs to all signing authorities for ensuring at application signing time that any executables contained in application packages contain the correct VIDs.

2. A computing device arranged to operate in accordance with a method as claimed in claim 1.

3. An operating system for causing a computing device to operate in accordance with a method as claimed in claim 1.
